(19) United States
(12) Patent Application Publication
(10) Pub. No.: US 2024/0202510 A1
(43) Pub. Date: Jun. 20, 2024

(54) TECHNIQUES FOR ANALYSIS OF SYNAPSES FOR NEUROMORPHIC ARRAYS

(71) Applicant: Micron Technology, Inc., Boise, ID (US)

(72) Inventor: Sherif Amer, Boise, ID (US)

(21) Appl. No.: 18/513,397

(22) Filed: Nov. 17, 2023

Related U.S. Application Data
(60) Provisional application No. 63/432,910, filed on Dec. 15, 2022.

(51) Int. Cl. G06N 3/063

(52) U.S. Cl. CPC G06N 3/063

(57) ABSTRACT

Methods, systems, and devices for techniques for analysis of synapses for neuromorphic arrays are described. A neuromorphic system may be configured such that each neuron reads a single synaptic circuit at a time. The synaptic circuit may receive a voltage pulse. Due to variability in individual synaptic circuits, various synaptic circuits may activate due to a voltage pulse while other synaptic circuits may not activate when exposed to a voltage pulse of the same property. Information associated with activating the synaptic circuits may contribute to a statistical distribution of the synaptic elements, which may be used to model and characterize the neuromorphic system and allow for more accurate neuromorphic system programming.

### CROSS-REFERENCES

The present Application for Patent claims the benefit of U.S. Provisional Patent Application No. 63/432,910 by Amer, entitled “TECHNIQUES FOR ANALYSIS OF SYNAPSES FOR NEUROMORPHIC ARRAYS,” filed Dec. 15, 2022, which is assigned to the assignee hereof, and which is hereby incorporated by reference in its entirety.

### TECHNICAL FIELD

The following relates to one or more systems for memory, including techniques for analysis of synapses for neuromorphic arrays.

### BACKGROUND

Memory devices are widely used to store information in various electronic devices such as computers, user devices, wireless communication devices, cameras, digital displays, and the like. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, a component may read (e.g., sense, detect, retrieve, identify, determine, evaluate) a stored state in the memory device. To store information, a component may write (e.g., program, set, assign) the state in the memory device.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not—or (NOR) and not—and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 illustrates an example of a system that supports techniques for analysis of synapses for neuromorphic arrays in accordance with examples as disclosed herein.

FIG. 2 illustrates an example of a memory die that supports techniques for analysis of synapses for neuromorphic arrays in accordance with examples as disclosed herein.

FIG. 3 illustrates an example of a neuromorphic system that supports techniques for analysis of synapses for neuromorphic arrays in accordance with examples as disclosed herein.

FIGS. 4A and 4B illustrate examples of plots that support techniques for analysis of synapses for neuromorphic arrays in accordance with examples as disclosed herein.

FIGS. 5A and 5B illustrate examples of plots that support techniques for analysis of synapses for neuromorphic arrays in accordance with examples as disclosed herein.

FIG. 6 illustrates a block diagram of a memory device that supports techniques for analysis of synapses for neuromorphic arrays in accordance with examples as disclosed herein.

FIG. 7 illustrates a flowchart showing a method or methods that support techniques for analysis of synapses for neuromorphic arrays in accordance with examples as disclosed herein.

### DETAILED DESCRIPTION

Some memory systems, such as analog memory systems, including neuromorphic systems, may have low tolerances for variations in the analog charge stored in the memory cells that form the synaptic circuits. In some cases, characterization of neuromorphic systems may rely on models of a single synaptic circuit of the neuromorphic system. However, the characteristics of a single synaptic circuit might not apply sufficiently to other synaptic circuits to provide a sufficient model of a neuromorphic system. Put another way, a model based on characteristics of a single synaptic circuit might be inapplicable for larger memory systems (e.g., neuromorphic systems) that includes a large quantity of synaptic circuits.

Various aspects of the present disclosure relate to determining statistical properties of a memory system (also referred to as a neuromorphic system). Forming a model of an artificial neuron system as described herein may enable the extraction of characteristics of synaptic circuits as well as associated statistics of the neuromorphic system. The statistics of the system (e.g., distribution, mean, variability, etc.) may be used to derive other useful metrics. A neuromorphic system may be configured such that each neuron reads a single synaptic circuit at a time. The synaptic circuit may receive a voltage pulse with certain properties (e.g., width, height, duration, amplitude, etc.). Whether the synaptic circuit activates (e.g., fires) or not, due to the voltage pulse, may be recorded. Various synaptic circuits (e.g., a row of synaptic circuits, each synaptic circuit in the row corresponding to a different neuron) may be analyzed (e.g., tested) with the same voltage pulse. Other voltage pulses with the same properties may be used to analyze various (e.g., multiple rows of) synaptic circuits. Due to variability, various synaptic circuits may activate due to a voltage pulse while other synaptic circuits may not activate when exposed to a voltage pulse of the same property. Information associated with activating the synaptic circuits (e.g., the ratio of neuron circuits that fire to the total quantity of tested neurons for each voltage pulse) may contribute to a statistical distribution of the synaptic circuits. The statistical distribution may be analyzed and used to characterize the neuromorphic system. The characterization of the neuromorphic system may be used to generate a model that allows for more accurate programming of the system.

The various aspects of the present disclosure related to analysis of synaptic circuits and generation of a model applicable to a neuromorphic system that includes a plurality of synaptic circuits is scalable and may be used to characterize arbitrarily large arrays. Various aspects of the present disclosure related to neuromorphic systems may also be automated and readily be used to process large volumes of data. For example, a synaptic circuit may be analyzed using various voltage pulse properties, while the synaptic circuit is part of an array in a fabricated chip. The various aspects of the present disclosure might mitigate the usefulness of a single synaptic circuit being analyzed in isolation. A more accurate characterization of synaptic circuits may improve their performance and robustness in neuromorphic applications and may be a step toward improving products (e.g., chips) that use artificial intelligence.

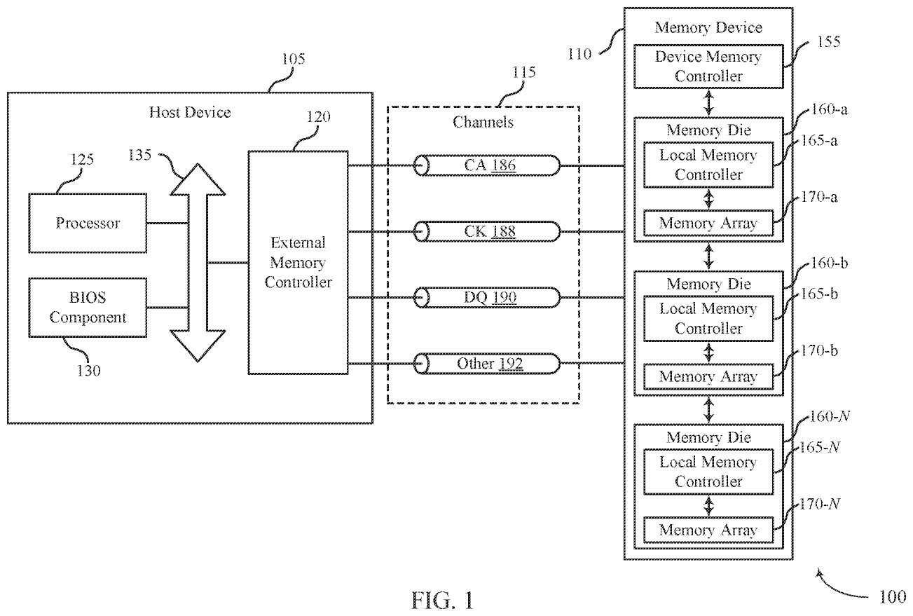

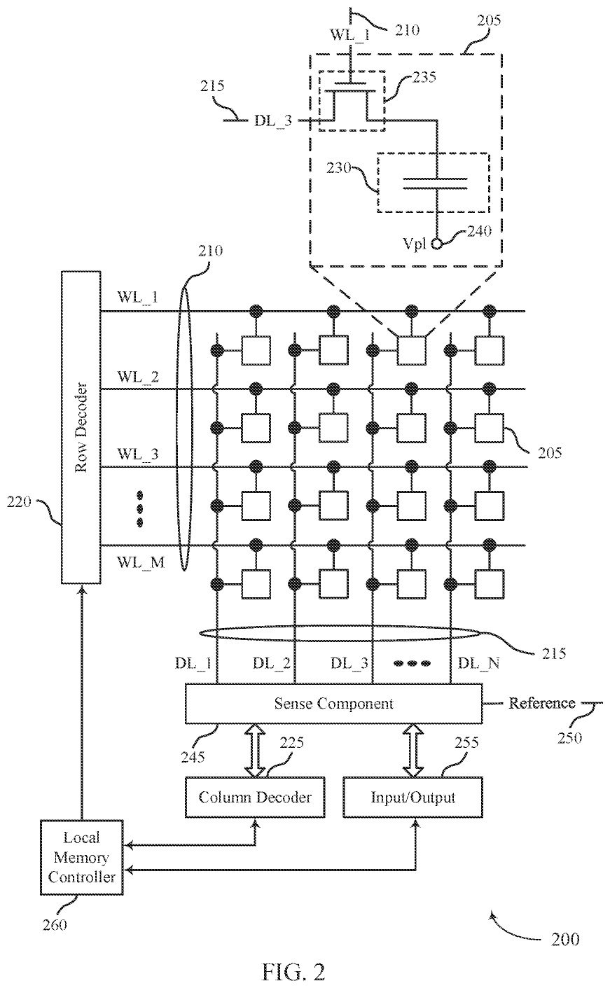

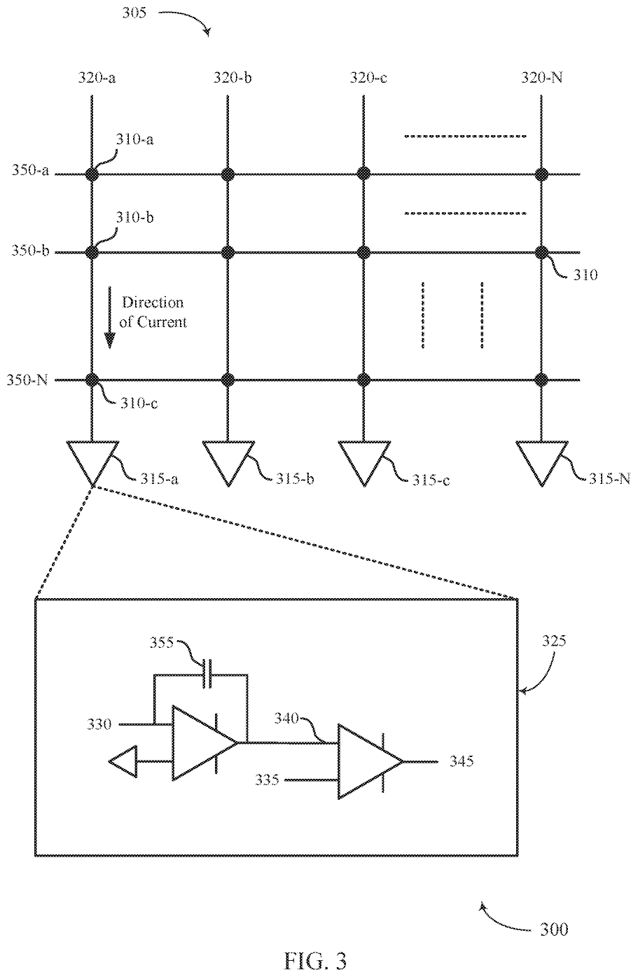

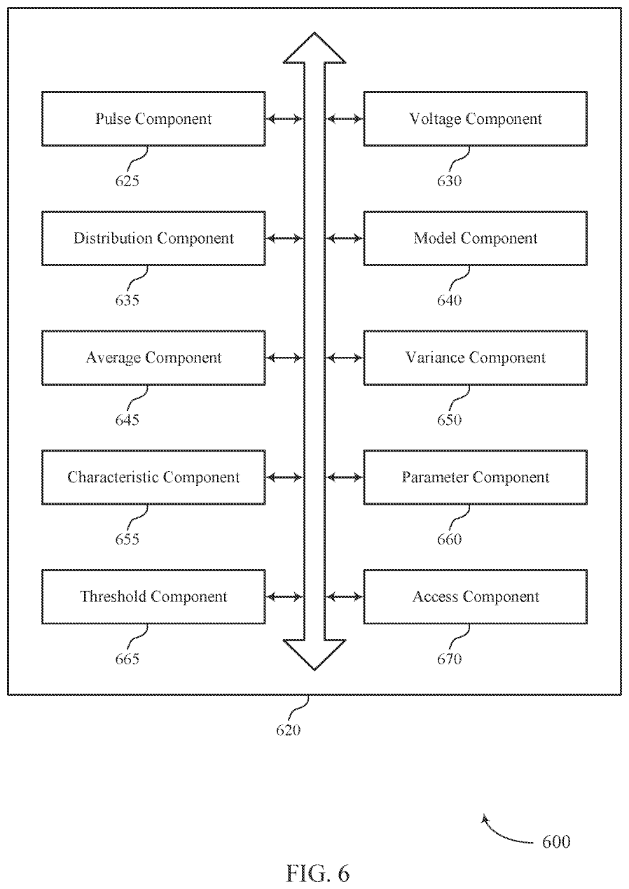

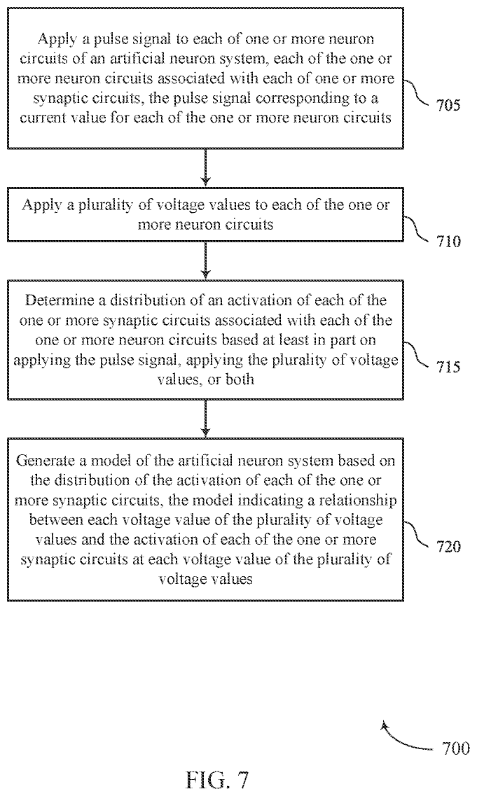

Features of the disclosure are initially described in the context of systems and dies as described with reference to FIGS. 1 and 2. Features of the disclosure are described in the context of neuromorphic systems and information from analyzing synaptic elements as described with reference to FIGS. 3 through 5B. These and other features of the disclosure are further illustrated by and described with reference to an apparatus diagram and flowcharts that relate to techniques for analysis of synapses for neuromorphic arrays as described with reference to FIGS. 6 and 7.

FIG. 1 illustrates an example of a system 100 that supports techniques for analysis of synapses for neuromorphic arrays in accordance with examples as disclosed herein. The system 100 may include a host device 105, a memory device 110, and a plurality of channels 115 coupling the host device 105 with the memory device 110. The system 100 may include one or more memory devices 110, but aspects of the one or more memory devices 110 may be described in the context of a single memory device (e.g., memory device 110).

The system 100 may include portions of an electronic device, such as a computing device, a mobile computing device, a wireless device, a graphics processing device, a vehicle, or other systems. For example, the system 100 may illustrate aspects of a computer, a laptop computer, a tablet computer, a smartphone, a cellular phone, a wearable device, an internet-connected device, a vehicle controller, or the like. The memory device 110 may be a component of the system 100 that is operable to store data for one or more other components of the system 100.

Portions of the system 100 may be examples of the host device 105. The host device 105 may be an example of a processor (e.g., circuitry, processing circuitry, a processing component) within a device that uses memory to execute processes, such as within a computing device, a mobile computing device, a wireless device, a graphics processing device, a computer, a laptop computer, a tablet computer, a smartphone, a cellular phone, a wearable device, an internet-connected device, a vehicle controller, a system on a chip (SoC), or some other stationary or portable electronic device, among other examples. In some examples, the host device 105 may refer to the hardware, firmware, software, or any combination thereof that implements the functions of an external memory controller 120. In some examples, the external memory controller 120 may be referred to as a host (e.g., host device 105).

A memory device 110 may be an independent device or a component that is operable to provide physical memory addresses/space that may be used or referenced by the system 100. In some examples, a memory device 110 may be configurable to work with one or more different types of host devices. Signaling between the host device 105 and the memory device 110 may be operable to support one or more of: modulation schemes to modulate the signals, various pin configurations for communicating the signals, various form factors for physical packaging of the host device 105 and the memory device 110, clock signaling and synchronization between the host device 105 and the memory device 110, timing conventions, or other functions.

The memory device 110 may be operable to store data for the components of the host device 105. In some examples, the memory device 110 (e.g., operating as a secondary-type device to the host device 105, operating as a dependent-type device to the host device 105) may respond to and execute commands provided by the host device 105 through the external memory controller 120. Such commands may include one or more of a write command for a write operation, a read command for a read operation, a refresh command for a refresh operation, or other commands.

The host device 105 may include one or more of an external memory controller 120, a processor 125, a basic input/output system (BIOS) component 130, or other components such as one or more peripheral components or one or more input/output controllers. The components of the host device 105 may be coupled with one another using a bus 135.

The processor 125 may be operable to provide functionality (e.g., control functionality) for the system 100 or the host device 105. The processor 125 may be a general-purpose processor, a digital signal processor (DSP), an application-specific integrated circuit (ASIC), a field-programmable gate array (FPGA) or other programmable logic device, discrete gate or transistor logic, discrete hardware components, or any combination of these components. In such examples, the processor 125 may be an example of a central processing unit (CPU), a graphics processing unit (GPU), a general purpose GPU (GPGPU), or an SoC, among other examples. In some examples, the external memory controller 120 may be implemented by or be a part of the processor 125.

The BIOS component 130 may be a software component that includes a BIOS operated as firmware, which may initialize and run various hardware components of the system 100 or the host device 105. The BIOS component 130 may also manage data flow between the processor 125 and the various components of the system 100 or the host device 105. The BIOS component 130 may include instructions (e.g., a program, software) stored in one or more of read-only memory (ROM), flash memory, or other non-volatile memory.

The memory device 110 may include a device memory controller 155 and one or more memory dies 160 (e.g., memory chips) to support a capacity (e.g., a desired capacity, a specified capacity) for data storage. Each memory die 160 (e.g., memory die 160-a, memory die 160-b, memory die 160-N) may include a local memory controller 165 (e.g., local memory controller 165-a, local memory controller 165-b, local memory controller 165-N) and a memory array 170 (e.g., memory array 170-a, memory array 170-b, memory array 170-N). A memory array 170 may be a collection (e.g., one or more grids, one or more banks, one or more tiles, one or more sections) of memory cells, with each memory cell being operable to store one or more bits of data. A memory device 110 including two or more memory dies 160 may be referred to as a multi-die memory or a multi-die package or a multi-chip memory or a multi-chip package.

A memory die 160 may be an example of a two-dimensional (2D) array of memory cells or may be an example of a three-dimensional (3D) array of memory cells. In some examples, a 2D memory die 160 may include a single memory array 170. In some examples, a 3D memory die 160 may include two or more memory arrays 170, which may be stacked on top of one another or positioned next to one another (e.g., relative to a substrate). In some examples, memory arrays 170 in a 3D memory die 160 may be referred to as or otherwise include different sets (e.g., decks, levels, layers, dies). A 3D memory die 160 may include any quantity of stacked memory arrays 170 (e.g., two high, three high, four high, five high, six high, seven high, eight high). In some 3D memory dies 160, different decks may share a common access line such that some decks may share one or more of a word line, a digit line, or a plate line.

The device memory controller 155 may include components (e.g., circuitry, logic) operable to control operation of the memory device 110. The device memory controller 155 may include hardware, firmware, or instructions that enable the memory device 110 to perform various operations and may be operable to receive, transmit, or execute commands, data, or control information related to the components of the memory device 110. The device memory controller 155 may be operable to communicate with one or more of the external memory controller 120, the one or more memory dies 160, or the processor 125. In some examples, the device memory controller 155 may control operation of the memory device 110 described herein in conjunction with the local memory controller 165 of the memory die 160.

A local memory controller 165 (e.g., local to a memory die 160) may include components (e.g., circuitry, logic) operable to control operation of the memory die 160. In some examples, a local memory controller 165 may be operable to communicate (e.g., receive or transmit data or commands or both) with the device memory controller 155. In some examples, a memory device 110 may not include a device memory controller 155, and a local memory controller 165 or the external memory controller 120 may perform various functions described herein. As such, a local memory controller 165 may be operable to communicate with the device memory controller 155, with other local memory controllers 165, or directly with the external memory controller 120, or the processor 125, or any combination thereof. Examples of components that may be included in the device memory controller 155 or the local memory controllers 165 or both may include receivers for receiving signals (e.g., from the external memory controller 120), transmitters for transmitting signals (e.g., to the external memory controller 120), decoders for decoding or demodulating received signals, encoders for encoding or modulating signals to be transmitted, or various other components operable for supporting described operations of the device memory controller 155 or local memory controller 165 or both.

The external memory controller 120 may be operable to enable communication of information (e.g., data, commands, or both) between components of the system 100 (e.g., between components of the host device 105, such as the processor 125, and the memory device 110). The external memory controller 120 may process (e.g., convert, translate) communications exchanged between the components of the host device 105 and the memory device 110. In some examples, the external memory controller 120, or other component of the system 100 or the host device 105, or its functions described herein, may be implemented by the processor 125. For example, the external memory controller 120 may be hardware, firmware, or software, or some combination thereof implemented by the processor 125 or other component of the system 100 or the host device 105. Although the external memory controller 120 is depicted as being external to the memory device 110, in some examples, the external memory controller 120, or its functions described herein, may be implemented by one or more components of a memory device 110 (e.g., a device memory controller 155, a local memory controller 165) or vice versa.

The components of the host device 105 may exchange information with the memory device 110 using one or more channels 115. The channels 115 may be operable to support communications between the external memory controller 120 and the memory device 110. Each channel 115 may be an example of a transmission medium that carries information between the host device 105 and the memory device 110. Each channel 115 may include one or more signal paths (e.g., a transmission medium, a conductor) between terminals associated with the components of the system 100. A signal path may be an example of a conductive path operable to carry a signal. For example, a channel 115 may be associated with a first terminal (e.g., including one or more pins, including one or more pads) at the host device 105 and a second terminal at the memory device 110. A terminal may be an example of a conductive input or output point of a device of the system 100, and a terminal may be operable to act as part of a channel.

Channels 115 (and associated signal paths and terminals) may be dedicated to communicating one or more types of information. For example, the channels 115 may include one or more command and address (CA) channels 186, one or more clock signal (CK) channels 188, one or more data (DQ) channels 190, one or more other channels 192, or any combination thereof. In some examples, signaling may be communicated over the channels 115 using single data rate (SDR) signaling or double data rate (DDR) signaling. In SDR signaling, one modulation symbol (e.g., signal level) of a signal may be registered for each clock cycle (e.g., on a rising or falling edge of a clock signal). In DDR signaling, two modulation symbols (e.g., signal levels) of a signal may be registered for each clock cycle (e.g., on both a rising edge and a falling edge of a clock signal).

In the system 100, a memory array 170 may be a neuromorphic array, which may include one or multiple synaptic circuits and one or multiple neuron circuits. Each synaptic circuit may be configured with a programmable resistance that can store an analog value of a synaptic weight. One or more synapses, while in the memory array 170, may be analyzed to generate a model (e.g., a statistical model) for the memory array 170. For example, the system 100 may apply a pulse signal to each of one or more neuron circuits of the memory array 170 (e.g., a neuromorphic array). Each of the one or more neuron circuits may be associated with each of one or more synaptic circuits. The pulse signal may correspond to a current value for each of the one or more neuron circuits. The system 100 may apply a plurality of voltage values to each of the one or more neuron circuits. The system 100 may determine a distribution of an activation of each of the one or more synaptic circuits associated with each of the one or more neuron circuits based on applying the pulse signal, applying the plurality of voltage values, or both. The system 100 may generate a model based on the distribution of the activation of each of the one or more synaptic circuits. The model may indicate a relationship between each voltage value of the plurality of voltage values and the activation of each of the one or more synaptic circuits at each voltage value of the plurality of voltage values.

FIG. 2 illustrates an example of a memory die 200 that supports techniques for analysis of synapses for neuromorphic arrays in accordance with examples as disclosed herein. The memory die 200 may be an example of the memory dies 160 described with reference to FIG. 1. In some examples, the memory die 200 may be referred to as a memory chip, a memory device, or an electronic memory apparatus. The memory die 200 may include one or more memory cells 205 that may be programmable to store different logic states (e.g., programmed to one of a set of two or more possible states). For example, a memory cell 205 may be operable to store one bit of information at a time (e.g., a logic 0 or a logic 1). In some examples, a memory cell 205 (e.g., a multi-level memory cell) may be operable to store more than one bit of information at a time (e.g., a logic 00, logic 01, logic 10, a logic 11). In some examples, the memory cells 205 may be arranged in an array, such as a memory array 170 described with reference to FIG. 1. The memory die 200 may be analogous to the neuromorphic array 305 in FIG. 3, for example a memory cell 205 may be analogous to a synapse 310 and a sense amplifier included in a sense component 245 may be analogous to a neuron 315.

in some examples, a memory cell 205 may store a charge representative of the programmable states in a capacitor. DRAM architectures may include a capacitor that includes a dielectric material to store a charge representative of the programmable state. In other memory architectures, other storage devices and components are possible. For example, nonlinear dielectric materials may be employed. The memory cell 205 may include a logic storage component, such as capacitor 230, and a switching component 235 (e.g., a cell selection component). The capacitor 230 may be an example of a dielectric capacitor or a ferroelectric capacitor. A node of the capacitor 230 may be coupled with a voltage source 240, which may be the cell plate reference voltage, such as Vp1, or may be ground, such as Vss.

The memory die 200 may include access lines (e.g., word lines 210, digit lines 215) arranged in a pattern, such as a grid-like pattern. An access line may be a conductive line coupled with a memory cell 205 and may be used to perform access operations on the memory cell 205. In some examples, word lines 210 may be referred to as row lines. In some examples, digit lines 215 may be referred to as column lines or bit lines. References to access lines, row lines, column lines, word lines, digit lines, or bit lines, or their analogues, are interchangeable without loss of understanding. Memory cells 205 may be positioned at intersections of the word lines 210 and the digit lines 215.

Operations such as reading and writing may be performed on the memory cells 205 by activating access lines such as a word line 210 or a digit line 215. By biasing a word line 210 and a digit line 215 (e.g., applying a voltage to the word line 210 or the digit line 215), a single memory cell 205 may be accessed at their intersection. The intersection of a word line 210 and a digit line 215 in a two-dimensional or in a three-dimensional configuration may be referred to as an address of a memory cell 205. Activating a word line 210 or a digit line 215 may include applying a voltage to the respective line.

Accessing the memory cells 205 may be controlled through a row decoder 220, or a column decoder 225, or any combination thereof. For example, a row decoder 220 may receive a row address from the local memory controller 260 and activate a word line 210 based on the received row address. A column decoder 225 may receive a column address from the local memory controller 260 and may activate a digit line 215 based on the received column address.

Selecting or deselecting the memory cell 205 may be accomplished by activating or deactivating the switching component 235 using a word line 210. The capacitor 230 may be coupled with the digit line 215 using the switching component 235. For example, the capacitor 230 may be isolated from digit line 215 when the switching component 235 is deactivated, and the capacitor 230 may be coupled with digit line 215 when the switching component 235 is activated.

A word line 210 may be a conductive line in electronic communication with a memory cell 205 that is used to perform access operations on the memory cell 205. In some architectures, the word line 210 may be coupled with a gate of a switching component 235 of a memory cell 205 and may be operable to control the switching component 235 of the memory cell. In some architectures, the word line 210 may be coupled with a node of the capacitor of the memory cell 205 and the memory cell 205 may not include a switching component.

A digit line 215 may be a conductive line that couples the memory cell 205 with a sense component 245. In some architectures, the memory cell 205 may be selectively coupled with the digit line 215 during portions of an access operation. For example, the word line 210 and the switching component 235 of the memory cell 205 may be operable to couple or isolate the capacitor 230 of the memory cell 205 and the digit line 215. In some architectures, the memory cell 205 may be coupled with the digit line 215.

The sense component 245 may be operable to detect a state (e.g., a charge) stored on the capacitor 230 of the memory cell 205 and determine a logic state of the memory cell 205 based on the stored state. The sense component 245 may include one or more sense amplifiers to amplify or otherwise convert a signal resulting from accessing the memory cell 205. The sense component 245 may compare a signal detected from the memory cell 205 to a reference 250 (e.g., a reference voltage). The detected logic state of the memory cell 205 may be provided as an output of the sense component 245 (e.g., to an input/output 255), and may indicate the detected logic state to another component of a memory device (e.g., a memory device 110) that includes the memory die 200.

The local memory controller 260 may control the accessing of memory cells 205 through the various components (e.g., row decoder 220, column decoder 225, sense component 245). The local memory controller 260 may be an example of the local memory controller 165 described with reference to FIG. 1. In some examples, one or more of the row decoder 220, column decoder 225, and sense component 245 may be co-located with the local memory controller 260. The local memory controller 260 may be operable to receive one or more of commands or data from one or more different memory controllers (e.g., an external memory controller 120 associated with a host device 105, another controller associated with the memory die 200), translate the commands or the data (or both) into information that can be used by the memory die 200, perform one or more operations on the memory die 200, and communicate data from the memory die 200 to a host (e.g., a host device 105) based on performing the one or more operations. The local memory controller 260 may generate row signals and column address signals to activate the target word line 210 and the target digit line 215. The local memory controller 260 also may generate and control various signals (e.g., voltages, currents) used during the operation of the memory die 200. In general, the amplitude, the shape, or the duration of an applied voltage or current discussed herein may be varied and may be different for the various operations discussed in operating the memory die 200.

The local memory controller 260 may be operable to perform one or more access operations on one or more memory cells 205 of the memory die 200. Examples of access operations may include a write operation, a read operation, a refresh operation, a precharge operation, or an activate operation, among others. In some examples, access operations may be performed by or otherwise coordinated by the local memory controller 260 in response to various access commands (e.g., from a host device 105). The local memory controller 260 may be operable to perform other access operations not listed here or other operations related to the operating of the memory die 200 that are not directly related to accessing the memory cells 205.

The local memory controller 260 may be operable to perform a read operation (e.g., a sense operation) on one or more memory cells 205 of the memory die 200. During a read operation, the state (e.g., logic state, charge state) stored in a memory cell 205 of the memory die 200 may be evaluated (e.g., read, determined, identified). The local memory controller 260 may identify a target memory cell 205 on which to perform the read operation. The local memory controller 260 may identify a target word line 210 and a target digit line 215 coupled with the target memory cell 205 (e.g., the address of the target memory cell 205). The local memory controller 260 may activate the target word line 210 and the target digit line 215 (e.g., applying a voltage to the word line 210 or digit line 215) to access the target memory cell 205. The target memory cell 205 may transfer a signal (e.g., charge, voltage) to the sense component 245 in response to biasing the access lines. The sense component 245 may amplify the signal. The local memory controller 260 may activate the sense component 245 (e.g., latch the sense component) and compare the signal received from the memory cell 205 to a reference (e.g., the reference 250). Based on that comparison, the sense component 245 may determine a logic state that is stored on the memory cell 205.

FIG. 3 illustrates an example of a neuromorphic system 300 that supports techniques for analysis of synapses for neuromorphic arrays in accordance with examples as disclosed herein. The neuromorphic system 300 may be referred to as an artificial neuron system. The neuromorphic system 300 may include a neuromorphic array 305, which may include one or more elements of the memory die 200 in FIG. 2, for example a synapse 310 may be analogous to a memory cell 205 and a neuron 315 may be analogous to a sense amplifier included in a sense component 245. The neuromorphic array 305 may be organized in a crossbar fashion with a synapse 310 at each cross point and a neuron 315 corresponding to each column 320. As an example, the neuromorphic array 305 may include chalcogenide or oxide-based devices. A synapse 310 may be referred to as a synaptic circuit or a synaptic device. Each of the one or more synapses 310 may include a plurality of synaptic circuit elements, and the plurality of synaptic circuit elements may include a plurality of memory cells. A synapse 310 may be able to hold an analog value, may be able to store a spectrum of analog synaptic weight, and may have a conductance that is electrically modulated. A neuron 315 may be referred to as a neuron circuit. As an example, the neurons 315 may be Integrate-And-Fire (IAF) neurons and may include circuitry similar to the neuron circuitry 325.

Each synapse 310 may include a programmable resistance that can store the analog value of the synaptic weight. A column 320 may contain current that flows through each of the synapses 310 corresponding to that column 320 and then to the corresponding neuron 315. For example, the current of a column 320-a may flow through synapse 310-a, then synapse 310-b, synapse 310-c, and the neuron 315-a. The current that flows into a neuron 315 may be referred to as the input current 330. As an example, the neuromorphic array 305 may include IAF neurons that adhere to Equation 1:

$${I}_{i n} = \sum V \cdot G \qquad ( 1 )$$

where Iᵢₙ represents the input current 330 of a neuron 315 (in other words, the accumulated current at a neuron 315). V represents the voltage pulse signal 350 of the row (e.g., a programming voltage pulse signal), and G represents the synaptic weight of a synapse 310. The sum is taken over all synapses 310 that correspond to the neuron 315.

The input programming voltage pulse signal 350 of each row of the neuromorphic array 305 may be multiplied (e.g., using the dot product or Ohm's law) by the synaptic weight of each corresponding synapses 310 of the row. Each column accumulates the voltage at the input of the neuron 315. The accumulated voltage may be referred to as a membrane voltage 340. The accumulated input current may be converted into the membrane voltage 340 by using Equation 2:

$$Δ {V}_{mem} = \frac{- Δ T}{{C}_{mem}} \cdot {I}_{i n} \qquad ( 2 )$$

where Vₘₑₘ refers to the membrane voltage 340, Cₘₑₘ refers to the membrane capacitance 355, ΔT refers to a change in time, and Iᵢₙ refers to the input current 330.

The membrane voltage 340 may be compared with a threshold voltage 335. If the membrane voltage 340 is equal to or higher than the threshold voltage 335, then the neuron may fire (e.g., output a high voltage 345). A firing neuron may be referred to as an activated neuron, and neuron firing may be referred to as neuron activation. The neuron may fire according to the model of Equation 3:

$$fire = \{ \begin{matrix}0 , & {V}_{mem} < {V}_{th} \\ 1 , & {V}_{mem} \geq {V}_{th}\end{matrix} \qquad ( 3 )$$

where Vₘₑₘ refers to the membrane voltage 340 of the neuron and Vₜₕ refers to the threshold voltage 335. There may be hardware that is configured to change the threshold voltage 335 of the one or more neurons 315 to be a different voltage level.

The neuromorphic system 300 may apply a voltage pulse signal 350 to each of one or more neuron 315, each neuron 315 may be associated with one or more synapses 310. The voltage pulse signal 350 have any pulse shape, width, height, amplitude, duration, quantity of sub-pulses, etc. or combination thereof, may be based on some conditions (e.g., predefined conditions), and may be dynamically altered. The pulse shape, width, height, amplitude, duration, quantity of sub-pulses, etc. or combination thereof may determine a set of parameters associated with the voltage pulse signal 350. Additionally or alternatively, the set of parameters associated with the voltage pulse signal 350 may be determined based on the activation of each of the one or more synapses 310 for each of the one or more neurons 315. Voltage pulse signal 350 generation may be based on the set of parameters associated with the voltage pulse signal 350. Applying the voltage pulse signal 350 may be based on generating the voltage pulse signal 350. The voltage pulse signal 350 may correspond to (e.g., comprise) a current value (e.g., a current pulse signal) for each of the one or more neurons 315. The current pulse signal may be based on a voltage value and a conductance value associated with each of the one or more neurons 315. There may be hardware to dynamically alter the pulse shape, width, height, amplitude, duration, quantity of sub-pulses, etc.

A plurality of voltage values may be applied to each of the one or more neurons 315. For example, voltage pulse signal 350-a may be different than, or the same as, voltage pulse signal 350-b. Each voltage value of the plurality of voltage values may be applied separately, with each voltage value corresponding to a different voltage value of the plurality of voltage values.

The neuromorphic array 305 may be configured such that each neuron 315 reads one synapse 310 at a time. In other words, the neuromorphic array 305 may be configured such that the input current 330 may reflect the state of a single synapse 310 at a time. For example, Equation 1 may be simplified for the neuron 315-a and the synapse 310-a, corresponding to voltage pulse signal 350-a, and the first column 320-a, as depicted in Equation 4:

$${I}_{i n} = {V}_{350 a} \cdot {G}_{350 - a , 320 - a} \qquad ( 4 )$$

where Iᵢₙ refers to the input current for the neuron 315-a, V₃₅₀₋ₐ refers to the voltage pulse signal 350-a, and G_{350-a,320-a} refers to the synaptic weight of the synapse 310-a (at the intersection of the first row, with the voltage pulse signal 350-a, and the first column 320-a).

The neuromorphic array 305 may record the firing or not-firing or each synapse 310 (e.g., activation or lack of activation of the corresponding neuron 315) for a variety of threshold voltages 335. In other words, the array may sweep through many threshold voltages 335. Due to variability of the synapses 310, not all synapses 310 will be programmed to the same synaptic weight for a given programming voltage pulse signal 350. Thus, for a given threshold voltage 335, some synapses 310 may fire while others may not. For example, small variations in manufacturing may produce variations in the performance of the synapses. The neuron fire model can be described using the Cumulative Distribution Function of the membrane voltage 340 evaluated at the threshold voltage 335, in Equation 5:

$$fire = \{ \begin{matrix}0 , & Pr ( {V}_{mem} < {V}_{th} ) \\ 1 , & Pr ( {V}_{mem} \geq {V}_{th} )\end{matrix} \qquad ( 5 )$$

where Vₘₑₘ refers to the membrane voltage of the neuron and Vₜₕ refers to the threshold voltage, and Pr refers to the probability function. By testing many synapses 310, sweeping the threshold voltage 335, and recording the fire ratio (e.g., the ratio of the neurons 315 that fired to the total quantity of tested neurons 315 for each programming voltage pulse signal 350 and a given threshold voltage 335), a statistical distribution of the synapses 310 may be extracted for each programming voltage pulse signal 350.

The neuromorphic system 300 may determine a distribution of an activation of each of the one or more synapses 310 associated with each of the one or more neurons 315 based in part on applying the voltage pulse signal 350, based in part on applying the plurality of voltage values, or both. A model of the neuromorphic array 305 may be generated based on the distribution of the activation of each of the one or more synapses 310. The model may indicate a relationship between each voltage value of the plurality of voltage values and the activation of each of the one or more synapses 310 at each voltage value of the plurality of voltage values. The methods described herein enable the extraction of synaptic characteristics post fabrication (e.g., extraction of the characteristics of synapses 310 in a fabricated post-silicon neuromorphic array 305 product). A high volume of data may be analyzed, and the extraction of synaptic characteristics may be scalable. The methods described herein may be automated. The methods described herein may modulate the analog weight of the synapses 310, which may lead to using Ohm's law more in the calculations than current methods (e.g., opposed to dot products), which may lead to less area and less power used by the circuitry as well as more efficient and higher performing neuromorphic arrays 305.

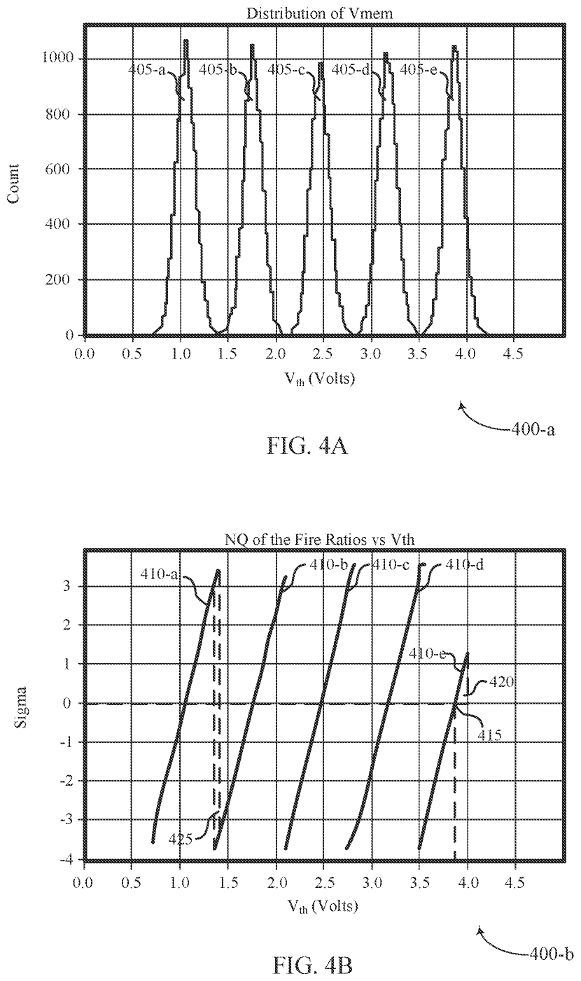

FIG. 4A illustrates an example of a diagram 400-a that supports techniques for analysis of synapses for neuromorphic arrays in accordance with examples as disclosed herein. The diagram 400-a uses example data to create a histogram of the neuron firings for each of various threshold voltages. For example, the histogram 405-a may contain data for a programming voltage pulse of 0.5 Volts, the histogram 405-b may contain data for a programming voltage pulse of 1.125 Volts, the histogram 405-c may contain data for a programming voltage pulse of 1.75 Volts, the histogram 405-d may contain data for a programming voltage pulse of 2.375 Volts, and the histogram 405-e may contain data for a programming voltage pulse of 3.0 Volts. Vₜₕ may refer to threshold voltage.

Data analysis may determine an average of each distribution 405 of the activation of each of the one or more synapses at each of one or more voltage values of the plurality of voltage values. Generating a model of the neuromorphic system may be based on the average of the distribution 405 of the activation of each of the one or more synapses at each of the one or more voltage values of the plurality of voltage values. The distribution 405 of the activation of each of one or more synapses may be determined based on determining that each of the one or more neurons satisfies the threshold. Determining that each of the one or more neurons satisfies the threshold may include determining that a stored voltage value associated with each of the one or more neurons is greater or equal to a voltage threshold. Data analysis on the distributions 405 may be used to determine a variance of the distributions 405 of activation of each of the one or more synapses at each of one or more voltage values of the plurality of voltage values. The model may be generated based in part on the variance of the distributions 405 of activation of each of the one or more synapses at each of the one or more voltage values of the plurality of voltage values.

The model may be used to find characteristics of the synapses in a post-silicon fabricated product and with few or no assumptions based on the characteristics of a single synapse in isolation. The model may be able to find the statistics of a neuromorphic array that may be extrapolated to allow for characterization of arrays larger than the analyzed array.

FIG. 4B illustrates an example of a diagram 400-b that supports techniques for analysis of synapses for neuromorphic arrays in accordance with examples as disclosed herein. The example data used for FIG. 4B is the same as the example data used for FIG. 4A. Diagram 4(X)-b shows the threshold voltage on the x-axis and it shows the deviation from the mean on the y-axis. For example, at zero (0) on the y axis, the average threshold voltage for a distribution associated with given voltage pulse. The various units on the y-axis show how many standard deviations away from the mean the distribution is. The histogram 405-a may correspond to distribution 410-a (data taken with a programming voltage pulse of 0.5 Volts), histogram 405-b may correspond to distribution 410-b (data taken with a programming voltage pulse of 1.125 Volts), histogram 405-c may correspond to distribution 410-c (data taken with a programming voltage pulse of 1.75 Volts), histogram 405-d may correspond to distribution 410-d (data taken with a programming voltage pulse of 2.375 Volts), and histogram 405-e may correspond to distribution 410-e (data taken with a programming voltage pulse of 3.0 Volts). Assuming the neurons exhibit minimal variability compared to the synapses (which may be justifiable because the neuron may be a complementary metal-oxide-semiconductor, which are better understood than emerging devices such as those used in synaptic elements), the synapse firing (e.g., activation) may follow a statistical distribution (e.g., a Gaussian distribution) as shown in distributions 405 in FIG. 4A. In this case, the normal quantile (NQ) of the fire ratio may be extracted and plotted against the threshold voltage, as depicted in the set of distributions 410 in the diagram 400-b. Sigma may refer to a standard deviation of the data around a mean 415. Vₜₕ may refer to threshold voltage. If the distributions 405 are normal, then the distributions 410 may plot as a straight line. Alternatively, any deviation from a straight line in the diagram 400-b may infer deviation from normality that may be due to the synapse or nonlinearity associated with the neuron. The pitch of a line in the diagram 400-b may indicate a tightness of the voltage threshold distribution. For example, a nearly vertical line may indicate a very tight distribution and a more horizontal line may indicate a more spread-out distribution.

Data analysis may determine one or more characteristics associated with each of the one or more synapses based on the distribution 410 of the activation of each of the one or more synaptic circuits. The voltage pulse signal may be based on the characteristics associated with each of the one or more synapses. Determining the characteristics associated with each of the one or more synaptic circuits may be based on a linear conductance model. The mean 415 and slope 420 of a distribution 410 may be determined based on the diagram 400-b. Regions of overlap 425 between the distributions 410 may also be determined based on the diagram 400-b. The threshold voltage when sigma is zero for a distribution 410 may be the mean 415 of the distribution 410. The mean 415 may correspond to the mean synaptic response to each programming voltage pulse and may contribute to a model for the distribution 410. The inverse of the slope 420 (e.g., dₜₕ/dSigma) may correspond to the variability of the synapses and may be used to quantify the impact of process variability on the performance of the neuromorphic array and/or may be used to design the programming voltage pulses for certain levels of variability.

Extracting the distribution 410 and its associated parameters may allow for extrapolating the neuromorphic arrays to larger sizes. Sizes of neuromorphic arrays that have not been fully tested (e.g., every synaptic circuit characterized) may still be modeled based on the model for a tested size (e.g., smaller size) of a neuromorphic array. In other words, the model is scalable. The model derived from the data analysis of a small quantity of circuits may be used to perform an access operation of a larger quantity of circuits in the memory array (e.g., the one or more synapses using the one or more neurons). Data analysis in accordance with examples herein may find the mean and/or median performance and the statistical performance of synapses in neuromorphic arrays.

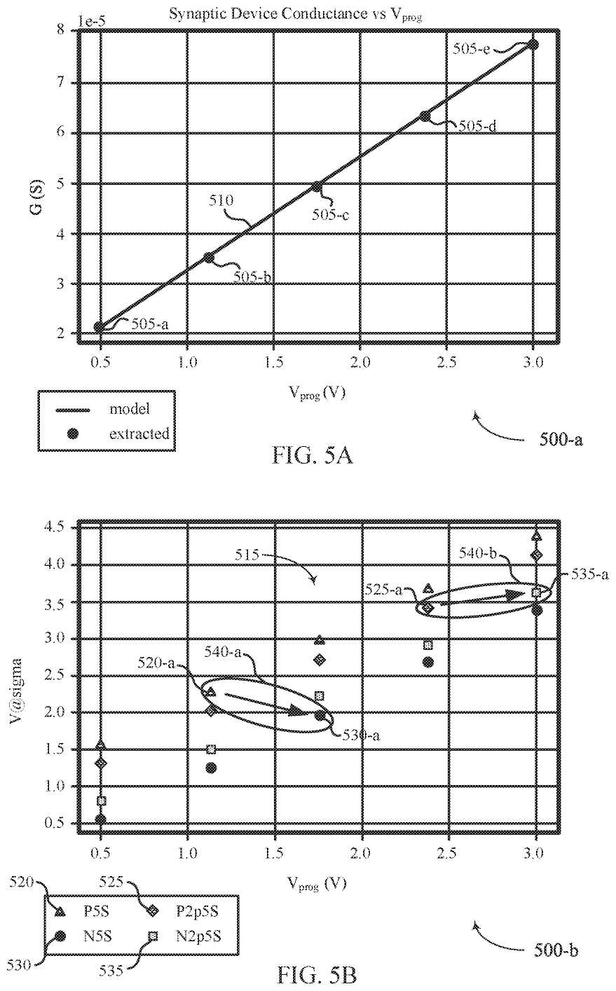

FIG. 5A illustrates an example of a diagram 500-a that supports techniques for analysis of synapses for neuromorphic arrays in accordance with examples as disclosed herein. The diagram 500-a is an example of an analysis that may be performed on the data from FIG. 4A. In the example of FIG. 5A, a data point 505-a may correspond to distribution 410-a (data taken with a programming voltage pulse of 0.5 Volts), a data point 505-b may correspond to distribution 410-b (data taken with a programming voltage pulse of 1.125 Volts), a data point 505-c may correspond to distribution 410-c (data taken with a programming voltage pulse of 1.75 Volts), a data point 505-d may correspond to distribution 410-d (data taken with a programming voltage pulse of 2.375 Volts), and a data point 505-e may correspond to distribution 410-e (data taken with a programming voltage pulse of 3.0 Volts). V_{prog} may refer to the amplitude of the programming voltage signal. G may refer to a synaptic weight in unis of conductance (G). The data points 505 may refer to the mean synaptic weight G (y-axis), with units of siemens (S), at a given programming voltage pulse (x-axis).

The data points 505 may be assumed, for simplicity, to be a linear synaptic device conductance model that adheres to Equation 6:

$$G = {G}_{min} + \frac{{G}_{max} - {G}_{min}}{δ} \cdot {V}_{prog} \qquad ( 6 )$$

where G represents the mean synaptic weight, Gₘᵢₙ represents the minimum synaptic weight, Gₘₐₓ, represents the maximum synaptic weight, sigma represents a standard deviation of the synaptic weight, and V_{prog} represents the programming voltage. The linear synaptic device conductance model may be used in an algorithm to extract the conductance of the synapses. The algorithm may be used to fit a line 510 through each data point 505. The line 510 may be used to extract the y-intercept and slope of the fitted linear model, as well as predict what programming voltage to use to obtain a desired mean synaptic weight for a neuromorphic array. For example, the y-intercept of the line 510 may be multiplied by the inverse neuron function to extract the conductance of the synapses.

FIG. 5B illustrates an example of a diagram 500-b that supports techniques for analysis of synapses for neuromorphic arrays in accordance with examples as disclosed herein. Like diagram 500-a, diagram 500-b is an example of an analysis that may be performed on the data from FIG. 4A. Data points 515 may represent the membrane voltage of a synapse at a given standard deviation away from the mean synaptic response, the synapse being undergoing a given programming voltage. As an example, the points 520 may refer to the mean synaptic weight plus 5 standard deviations (PSS), the points 525 may refer to the mean synaptic weight plus 2.5 standard deviations (P2p5S), the points 530 may refer to the mean synaptic weight minus 5 standard deviations (N5S), the points 535 may refer to the mean synaptic weight minus 2.5 standard deviations (N2p5S).

From the diagram 500-b, useful information can be extracted. For example, the data relationship between point 520-a and point 530-a shows an overlap 540-a. The overlap 540-a shows that a quantity (corresponding to the quantity of synapses positive 5 standard deviations or more away from the mean, point 520-a) of synapses programed with 1.125 Volts will have membrane voltages higher than the membrane voltages of a quantity (corresponding to the quantity of synapses negative 5 standard deviations or more away from the mean, point 530-a) of synapses programed with 1.75 Volts. For either programming voltage (e.g., 1.125 Volts and 1.75 Volts), some synapses will have membrane voltages between the membrane voltage corresponding to point 530-a and the membrane voltage corresponding to point 520-a, if the size of the array is large enough, due to statistics and synaptic device variability.

Similarly, the data relationship between point 525-a and 535-a shows an overlap 540-b. The overlap 540-b shows that a quantity (corresponding to the quantity of synapses positive 2.5 standard deviations or more away from the mean, point 525-a) of synapses programed with 2.375 Volts will have membrane voltages higher than the membrane voltages of a quantity (corresponding to the quantity of synapses negative 2.5 standard deviations or more away from the mean, point 535-a) of synapses programed with 3.0 Volts. For either programming voltage (e.g., 2.375 Volts and 3.0 Volts), some synapses will have membrane voltages between the membrane voltage corresponding to point 525-a and the membrane voltage corresponding to point 535-a, if the size of the array is large enough, due to statistics and synaptic device variability.

The amount of overlap between data groups may be found for arbitrary sigma levels using Equation 7:

$${V}_{mem @ sigma} = intercept + slope \times sigma$$

where V_{mem@sigma} represents the membrane voltage for a synapse representative of the data at a given quantity of standard deviations (sigmas) away from the mean. The intercept and slope are from the line 510 of FIG. 5A. Analyzing the voltage membrane overlap for various programming voltages may assist in evaluating the impact of process variability on the array.

A non-transitory computer-readable medium may store code that includes instructions executable by a processor. The instructions may include methods and analyses as described with respect to FIGS. 3 through 5B. An apparatus may include a processor, memory coupled with the processor, and instructions stored in the memory and executable by the processor to cause the apparatus to perform methods and analyses as described with respect to FIGS. 3 through 5B.

FIG. 6 illustrates a block diagram 600 of a memory device 620 that supports techniques for analysis of synapses for neuromorphic arrays in accordance with examples as disclosed herein. The memory device 620 may be an example of aspects of a memory device as described with reference to FIGS. 1 through 5. The memory device 620, or various components thereof, may be an example of means for performing various aspects of techniques for analysis of synapses for neuromorphic arrays as described herein. For example, the memory device 620 may include a pulse component 625, a voltage component 630, a distribution component 635, a model component 640, an average component 645, a variance component 650, a characteristic component 655, a parameter component 660, a threshold component 665, an access component 670, or any combination thereof. Each of these components may communicate, directly or indirectly, with one another (e.g., via one or more buses).

The pulse component 625 may be configured as or otherwise support a means for applying a pulse signal (e.g., the input voltage pulse signal 350) to each of one or more neuron circuits (e.g., neurons 315) of an artificial neuron system, each of the one or more neuron circuits associated with each of one or more synaptic circuits (e.g., synapses 310), the pulse signal corresponding to a current value for each of the one or more neuron circuits. The voltage component 630 may be configured as or otherwise support a means for applying a plurality of voltage values to each of the one or more neuron circuits. The distribution component 635 may be configured as or otherwise support a means for determining a distribution of an activation of each of the one or more synaptic circuits associated with each of the one or more neuron circuits based on applying the pulse signal, applying the plurality of voltage values, or both. The model component 640 may be configured as or otherwise support a means for generating a model of the artificial neuron system based on the distribution of the activation of each of the one or more synaptic circuits, the model indicating a relationship between each voltage value of the plurality of voltage values and the activation of each of the one or more synaptic circuits at each voltage value of the plurality of voltage values.

In some examples, the average component 645 may be configured as or otherwise support a means for determining an average of the distribution of the activation of each of the one or more synaptic circuits at each of one or more voltage values of the plurality of voltage values. In some examples, the model component 640 may be configured as or otherwise support a means for generating the model of the artificial neuron system based on the average of the distribution of the activation of each of the one or more synaptic circuits at each of the one or more voltage values of the plurality of voltage values.

In some examples, the variance component 650 may be configured as or otherwise support a means for determining a variance of the distribution of the activation of each of the one or more synaptic circuits at each of one or more voltage values of the plurality of voltage values. In some examples, the model component 640 may be configured as or otherwise support a means for generating the model based on the variance of the distribution of the activation of each of the one or more synaptic circuits at each of the one or more voltage values of the plurality of voltage values. The model may be associated with diagrams 400-a, 400-b, 500-a, and 500-b.

In some examples, the characteristic component 655 may be configured as or otherwise support a means for determining a characteristic associated with each of the one or more synaptic circuits based on the distribution of the activation of each of the one or more synaptic circuits. In some examples, the pulse signal is based on the characteristic associated with each of the one or more synaptic circuits. In some examples, the characteristic component 655 may be configured as or otherwise support a means for determining the characteristic associated with each of the one or more synaptic circuits based on a linear conductance model.

In some examples, the parameter component 660 may be configured as or otherwise support a means for determining a set of parameters associated with the pulse signal based on a condition, the set of parameters including a pulse height, a pulse width, a pulse shape, or a combination thereof. In some examples, the pulse component 625 may be configured as or otherwise support a means for generating the pulse signal based on the set of parameters associated with the pulse signal. In some examples, the pulse component 625 may be configured as or otherwise support a means for applying the pulse signal based on generating the pulse signal. In some examples, the pulse signal includes a current pulse signal. In some examples, the current pulse signal is based on a voltage value and a conductance value associated with each of the one or more neuron circuits. In some examples, the parameter component 660 may be configured as or otherwise support a means for determining the set of parameters associated with the pulse signal based on the activation of each of the one or more synaptic circuits for each of the one or more neuron circuits.

In some examples, to support applying the plurality of voltage values, the voltage component 630 may be configured as or otherwise support a means for applying each voltage value of the plurality of voltage values separately. In some examples, each voltage value corresponds to a different voltage value of the plurality of voltage values.

In some examples, the threshold component 665 may be configured as or otherwise support a means for determining that each of the one or more neuron circuits satisfies a threshold. In some examples, the distribution component 635 may be configured as or otherwise support a means for determining the distribution of the activation of each of the one or more synaptic circuits based on determining that each of the one or more neuron circuits satisfies the threshold. In some examples, to support determining that each of the one or more neuron circuits satisfies the threshold, the threshold component 665 may be configured as or otherwise support a means for determining that a stored voltage value associated with each of the one or more neuron circuits is greater than or equal to a voltage threshold. In some examples, the distribution includes a statistical distribution. In some examples, the statistical distribution includes a Gaussian distribution. In some examples, each of the one or more synaptic circuits includes a plurality of synaptic circuit elements. In some examples, the plurality of synaptic circuit elements includes a plurality of memory cells.

In some examples, the access component 670 may be configured as or otherwise support a means for performing, based on the model, an access operation of the one or more synaptic circuits using the one or more one or more neuron circuits.

FIG. 7 illustrates a flowchart showing a method 700 that supports techniques for analysis of synapses for neuromorphic arrays in accordance with examples as disclosed herein. The operations of method 700 may be implemented by a memory device or its components as described herein. For example, the operations of method 700 may be performed by a memory device as described with reference to FIGS. 1 through 6, for example the neuromorphic system 300. In some examples, a memory device may execute a set of instructions to control the functional elements of the device to perform the described functions. Additionally, or alternatively, the memory device may perform aspects of the described functions using special-purpose hardware.

At 705, the method may include applying a pulse signal (e.g., voltage pulse signal 350) to each of one or more neuron circuits of an artificial neuron system, each of the one or more neuron circuits (e.g., neurons 315) associated with each of one or more synaptic circuits (e.g., synapses 310), the pulse signal corresponding to a current value for each of the one or more neuron circuits. The operations of 705 may be performed in accordance with examples as disclosed herein. In some examples, aspects of the operations of 705 may be performed by a pulse component 625 as described with reference to FIG. 6.

At 710, the method may include applying a plurality of voltage values to each of the one or more neuron circuits. The operations of 710 may be performed in accordance with examples as disclosed herein. In some examples, aspects of the operations of 710 may be performed by a voltage component 630 as described with reference to FIG. 6.

At 715, the method may include determining a distribution of an activation of each of the one or more synaptic circuits associated with each of the one or more neuron circuits based on applying the pulse signal, applying the plurality of voltage values, or both. The operations of 715 may be performed in accordance with examples as disclosed herein. In some examples, aspects of the operations of 715 may be performed by a distribution component 635 as described with reference to FIG. 6.

At 720, the method may include generating a model of the artificial neuron system based on the distribution of the activation of each of the one or more synaptic circuits, the model indicating a relationship between each voltage value of the plurality of voltage values and the activation of each of the one or more synaptic circuits at each voltage value of the plurality of voltage values. The operations of 720 may be performed in accordance with examples as disclosed herein. In some examples, aspects of the operations of 720 may be performed by a model component 640 as described with reference to FIG. 6.

In some examples, an apparatus as described herein may perform a method or methods, such as the method 700. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for applying a pulse signal to each of one or more neuron circuits of an artificial neuron system, each of the one or more neuron circuits associated with each of one or more synaptic circuits, the pulse signal corresponding to a current value for each of the one or more neuron circuits; applying a plurality of voltage values to each of the one or more neuron circuits; determining a distribution of an activation of each of the one or more synaptic circuits associated with each of the one or more neuron circuits based on applying the pulse signal, applying the plurality of voltage values, or both; and generating a model of the artificial neuron system based on the distribution of the activation of each of the one or more synaptic circuits, the model indicating a relationship between each voltage value of the plurality of voltage values and the activation of each of the one or more synaptic circuits at each voltage value of the plurality of voltage values.

Aspect 2: The method, apparatus, or non-transitory computer-readable medium of aspect 1, further including operations, features, circuitry, logic, means, or instructions, or any combination thereof for determining an average of the distribution of the activation of each of the one or more synaptic circuits at each of one or more voltage values of the plurality of voltage values and where generating the model of the artificial neuron system is based on the average of the distribution of the activation of each of the one or more synaptic circuits at each of the one or more voltage values of the plurality of voltage values.

Aspect 3: The method, apparatus, or non-transitory computer-readable medium of any of aspects 1 through 2, further including operations, features, circuitry, logic, means, or instructions, or any combination thereof for determining a variance of the distribution of the activation of each of the one or more synaptic circuits at each of one or more voltage values of the plurality of voltage values and where generating the model is based on the variance of the distribution of the activation of each of the one or more synaptic circuits at each of the one or more voltage values of the plurality of voltage values.

Aspect 4: The method, apparatus, or non-transitory computer-readable medium of any of aspects 1 through 3, further including operations, features, circuitry, logic, means, or instructions, or any combination thereof for determining a characteristic associated with each of the one or more synaptic circuits based on the distribution of the activation of each of the one or more synaptic circuits and where the pulse signal is based on the characteristic associated with each of the one or more synaptic circuits.

Aspect 5: The method, apparatus, or non-transitory computer-readable medium of aspect 4, where determining the characteristic associated with each of the one or more synaptic circuits is based on a linear conductance model.

Aspect 6: The method, apparatus, or non-transitory computer-readable medium of any of aspects 1 through 5, further including operations, features, circuitry, logic, means, or instructions, or any combination thereof for determining a set of parameters associated with the pulse signal based on a condition, the set of parameters including a pulse height, a pulse width, a pulse shape, or a combination thereof: generating the pulse signal based on the set of parameters associated with the pulse signal: and where applying the pulse signal is based on generating the pulse signal.

Aspect 7: The method, apparatus, or non-transitory computer-readable medium of aspect 6, where the pulse signal includes a current pulse signal and the current pulse signal is based on a voltage value and a conductance value associated with each of the one or more neuron circuits.

Aspect 8. The method, apparatus, or non-transitory computer-readable medium of any of aspects 6 through 7, where determining the set of parameters associated with the pulse signal is based on the activation of each of the one or more synaptic circuits for each of the one or more neuron circuits.

Aspect 9: The method, apparatus, or non-transitory computer-readable medium of any of aspects 1 through 8, where applying the plurality of voltage values includes operations, features, circuitry, logic, means, or instructions, or any combination thereof for applying each voltage value of the plurality of voltage values separately and where each voltage value corresponds to a different voltage value of the plurality of voltage values.

Aspect 10: The method, apparatus, or non-transitory computer-readable medium of any of aspects 1 through 9, further including operations, features, circuitry, logic, means, or instructions, or any combination thereof for determining that each of the one or more neuron circuits satisfies a threshold and where determining the distribution of the activation of each of the one or more synaptic circuits is based on determining that each of the one or more neuron circuits satisfies the threshold.

Aspect 11: The method, apparatus, or non-transitory computer-readable medium of aspect 10, where determining that each of the one or more neuron circuits satisfies the threshold includes operations, features, circuitry, logic, means, or instructions, or any combination thereof for determining that a stored voltage value associated with each of the one or more neuron circuits is greater than or equal to a voltage threshold.

Aspect 12: The method, apparatus, or non-transitory computer-readable medium of any of aspects 1 through 11, where the distribution includes a statistical distribution.

Aspect 13: The method, apparatus, or non-transitory computer-readable medium of aspect 12, where the statistical distribution includes a Gaussian distribution.

Aspect 14: The method, apparatus, or non-transitory computer-readable medium of any of aspects 1 through 13, where each of the one or more synaptic circuits includes a plurality of synaptic circuit elements and the plurality of synaptic circuit elements includes a plurality of memory cells.

Aspect 15: The method, apparatus, or non-transitory computer-readable medium of any of aspects 1 through 14, further including operations, features, circuitry, logic, means, or instructions, or any combination thereof for performing, based on the model, an access operation of the one or more synaptic circuits using the one or more one or more neuron circuits.

It should be noted that the methods described herein describe possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal: however, the signal may represent a bus of signals, where the bus may have a variety of bit widths.

The term “isolated” refers to a relationship between components in which signals are not presently capable of flowing between the components. Components are isolated from each other if there is an open circuit between them. For example, two components separated by a switch that is positioned between the components are isolated from each other when the switch is open. When a controller isolates two components, the controller affects a change that prevents signals from flowing between the components using a conductive path that previously permitted signals to flow.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorous, boron, or arsenic. Doping may be performed during the initial formation or growth of the substrate, by ion-implantation, or by any other doping means.

A switching component (e.g., a transistor) discussed herein may represent a field-effect transistor (FET) and may comprise a three-terminal component including a source (e.g., a source terminal), a drain (e.g., a drain terminal), and a gate (e.g., a gate terminal). The terminals may be connected to other electronic components through conductive materials (e.g., metals, alloys). The source and drain may be conductive, and may comprise a doped (e.g., heavily-doped, degenerate) semiconductor region. The source and drain may be separated by a doped (e.g., lightly-doped) semiconductor region or channel. If the channel is n-type (e.g., majority carriers are electrons), then the FET may be referred to as a n-type FET. If the channel is p-type (e.g., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” when a voltage greater than or equal to the transistor's threshold voltage is applied to the transistor gate. The transistor may be “off” or “deactivated” when a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

The functions described herein may be implemented in hardware, software executed by a processor, firmware, or any combination thereof. If implemented in software executed by a processor, the functions may be stored on or transmitted over as one or more instructions (e.g., code) on a computer-readable medium. Other examples and implementations are within the scope of the disclosure and appended claims. For example, due to the nature of software, functions described herein can be implemented using softhare executed by a processor, hardware, firmware, hardwiring, or combinations of any of these. Features implementing functions may also be physically located at various positions, including being distributed such that portions of functions are implemented at different physical locations.

For example, the various illustrative blocks and modules described in connection with the disclosure herein may be implemented or performed with a processor, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or any type of processor. A processor may also be implemented as a combination of computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A. B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a computer. By way of example, and not limitation, non-transitory computer-readable media can comprise RAM, ROM, electrically erasable programmable read-only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a computer, or a processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, digital subscriber line (DSL), or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method, comprising:
applying a pulse signal to each of one or more neuron circuits of an artificial neuron system, each of the one or more neuron circuits associated with each of one or more synaptic circuits, the pulse signal corresponding to a current value for each of the one or more neuron circuits;
applying a plurality of voltage values to each of the one or more neuron circuits;
determining a distribution of an activation of each of the one or more synaptic circuits associated with each of the one or more neuron circuits based on applying the pulse signal, applying the plurality of voltage values, or both; and
generating a model of the artificial neuron system based on the distribution of the activation of each of the one or more synaptic circuits, the model indicating a relationship between each voltage value of the plurality of voltage values and the activation of each of the one or more synaptic circuits at each voltage value of the plurality of voltage values.

2. The method of claim 1, further comprising:
determining an average of the distribution of the activation of each of the one or more synaptic circuits at each of one or more voltage values of the plurality of voltage values,
wherein generating the model of the artificial neuron system is based on the average of the distribution of the activation of each of the one or more synaptic circuits at each of the one or more voltage values of the plurality of voltage values.

3. The method of claim 1, further comprising:
determining a variance of the distribution of the activation of each of the one or more synaptic circuits at each of one or more voltage values of the plurality of voltage values,
wherein generating the model is based on the variance of the distribution of the activation of each of the one or more synaptic circuits at each of the one or more voltage values of the plurality of voltage values.

4. The method of claim 1, further comprising:
determining a characteristic associated with each of the one or more synaptic circuits based on the distribution of the activation of each of the one or more synaptic circuits,
wherein the pulse signal is based on the characteristic associated with each of the one or more synaptic circuits.

5. The method of claim 4, wherein determining the characteristic associated with each of the one or more synaptic circuits is based on a linear conductance model.

6. The method of claim 1, further comprising:
determining a set of parameters associated with the pulse signal based on a condition, the set of parameters comprising a pulse height, a pulse width, a pulse shape, or a combination thereof; and
generating the pulse signal based on the set of parameters associated with the pulse signal,
wherein applying the pulse signal is based on generating the pulse signal.

7. The method of claim 6, wherein the pulse signal comprises a current pulse signal, and the current pulse signal is based on a voltage value and a conductance value associated with each of the one or more neuron circuits.

8. The method of claim 6, wherein determining the set of parameters associated with the pulse signal is based on the activation of each of the one or more synaptic circuits for each of the one or more neuron circuits.

9. The method of claim 1, wherein applying the plurality of voltage values comprises:
applying each voltage value of the plurality of voltage values separately,
wherein each voltage value corresponds to a different voltage value of the plurality of voltage values.

10. The method of claim 1, further comprising:
determining that each of the one or more neuron circuits satisfies a threshold,
wherein determining the distribution of the activation of each of the one or more synaptic circuits is based on determining that each of the one or more neuron circuits satisfies the threshold.

11. The method of claim 10, wherein determining that each of the one or more neuron circuits satisfies the threshold comprises:
determining that a stored voltage value associated with each of the one or more neuron circuits is greater than or equal to a voltage threshold.

12. The method of claim 1, wherein the distribution comprises a statistical distribution.

13. The method of claim 12, wherein the statistical distribution comprises a Gaussian distribution.

14. The method of claim 1, wherein each of the one or more synaptic circuits comprises a plurality of synaptic circuit elements, and the plurality of synaptic circuit elements comprises a plurality of memory cells.

15. The method of claim 1, further comprising:
performing, based on the model, an access operation of the one or more synaptic circuits using the one or more neuron circuits.

16. A non-transitory computer-readable medium storing code, the code comprising instructions executable by a processor to:
apply a pulse signal to each of one or more neuron circuits of an artificial neuron system, each of the one or more neuron circuits associated with each of one or more synaptic circuits, the pulse signal corresponding to a current value for each of the one or more neuron circuits;
apply a plurality of voltage values to each of the one or more neuron circuits;
determine a distribution of an activation of each of the one or more synaptic circuits associated with each of the one or more neuron circuits based on applying the pulse signal, applying the plurality of voltage values, or both; and
generate a model of the artificial neuron system based on the distribution of the activation of each of the one or more synaptic circuits, the model indicating a relationship between each voltage value of the plurality of voltage values and the activation of each of the one or more synaptic circuits at each voltage value of the plurality of voltage values.

17. An apparatus, comprising:
a processor;
memory coupled with the processor; and
instructions stored in the memory and executable by the processor to cause the apparatus to:
apply a pulse signal to each of one or more neuron circuits of an artificial neuron system, each of the one or more neuron circuits associated with each of one or more synaptic circuits, the pulse signal corresponding to a current value for each of the one or more neuron circuits;
apply a plurality of voltage values to each of the one or more neuron circuits;
determine a distribution of an activation of each of the one or more synaptic circuits associated with each of the one or more neuron circuits based on applying the pulse signal, applying the plurality of voltage values, or both; and
generate a model of the artificial neuron system based on the distribution of the activation of each of the one or more synaptic circuits, the model indicating a relationship between each voltage value of the plurality of voltage values and the activation of each of the one or more synaptic circuits at each voltage value of the plurality of voltage values.

18. The apparatus of claim 17, wherein the instructions are further executable by the processor to cause the apparatus to:
determine an average of the distribution of the activation of each of the one or more synaptic circuits at each of one or more voltage values of the plurality of voltage values,
wherein to generate the model of the artificial neuron system is based on the average of the distribution of the activation of each of the one or more synaptic circuits at each of the one or more voltage values of the plurality of voltage values.

19. The apparatus of claim 17, wherein the instructions are further executable by the processor to cause the apparatus to:
determine a variance of the distribution of the activation of each of the one or more synaptic circuits at each of one or more voltage values of the plurality of voltage values,
wherein to generate the model is based on the variance of the distribution of the activation of each of the one or more synaptic circuits at each of the one or more voltage values of the plurality of voltage values.

20. The apparatus of claim 17, wherein the instructions are further executable by the processor to cause the apparatus to:
determine a characteristic associated with each of the one or more synaptic circuits based on the distribution of the activation of each of the one or more synaptic circuits,
wherein the pulse signal is based on the characteristic associated with each of the one or more synaptic circuits.
